(19) United States
(12) Patent Application Publication
(10) Pub. No.: US 2014/0063225 A1
(43) Pub. Date: Mar. 6, 2014

(54) MOTION-COMPENSATED CONFOCAL MICROSCOPE

(71) Applicants: Kang ZHANG, Baltimore, MD (US); Jin U. KANG, Ellicott City, MD (US); Yong HUANG, Baltimore, MD (US); The Johns Hopkins University, Baltimore, MD (US)

(72) Inventors: Jin U. Kang, Ellicott City, MD (US); Yong Huang, Baltimore, MD (US); Kang Zhang, Baltimore, MD (US)

(73) Assignee: The John Hopkins University, Baltimore, MD (US)

(21) Appl. No.: 14/114,885

(22) PCT Filed: May 4, 2012
(86) PCT No.: PCT/US2012/036643

§ 371 Date: Oct. 30, 2013

Related U.S. Application Data
(60) Provisional application No. 61/482,300, filed on May 4, 2011.

(51) Int. Cl. G01B 9/04

(52) U.S. Cl. CPC G01B 9/04
USPC 348/79

(57) ABSTRACT

A motion-compensated confocal microscope includes a laser scanning system, a fiber-optic component having a proximal end and a distal end such that the fiber-optic component is optically coupled to the laser scanning system to receive illumination light at the proximal end and to emit at least a portion of the illumination light at the distal end, and a detection system configured to receive and detect light returned from a specimen being observed and to output an image signal. The light returned from the specimen is received by the distal end of the fiber-optic component and transmitted back and out the proximal end of the fiber-optic component. The motion-compensated confocal microscope also includes a motion compensation system connected to at least one of the distal end of the fiber-optic component or to the specimen to move at least one of the distal end of the fiber-optic component or the specimen to compensate for relative motion between the distal end of the fiber-optic component and a portion of the specimen being observed.

### CROSS-REFERENCE OF RELATED APPLICATION

This application claims priority to U.S. Provisional Application No. 61/482,300 filed May 4, 2011, the entire contents of which are hereby incorporated by reference.

This invention was made with Government support of Grant No. R21 1R21NS063131-01A1, awarded by the Department of health and Human Services, The National Institutes of Health (NIH); and Grant No. IIP-0822695, awarded by NSF. The U.S. Government has certain rights in this invention.

### BACKGROUND

1. Field of Invention

The field of the currently claimed embodiments of this invention relates to motion-compensated confocal microscopes.

2. Discussion of Related Art

Confocal microscopy is a well-established 3-D imaging technique with high lateral and axial resolution [1]. The concept of using fiber-optic-component based confocal microscopy has been demonstrated to show high stability, ease of use, and flexibility [2-4]. Flexible coherent fiber bundles—consisting of tens of thousands of fiber channels—have been widely implemented for use in endoscopic confocal reflectance microscopy [5,6], two-photon laser scanning [7], and optical coherence tomography [8-10]. This design allows for a scan-less probe and probe miniaturization. It also has the advantage of separation of the scanning end and sample end and miniaturization. To improve imaging quality in vivo, a lens system must be customized and fitted to the fiber bundle. Confocal microscopy, based on a pair of GRIN lenses or objective lenses attached to a fiber bundle probe, has been studied [5, 11]. However, in vivo imaging of live samples can be significantly degraded due to the motions of live samples such as breathing, heart-beating, blood-flowing, and other physiological activities. Such motions result in intra- and inter-frame distortions, or even loss of the whole image frame [12]. For example, during the imaging of an embryo of a fruit fly during stem cell study, the accumulated muscle motion effect of the embryo can cause the imaging area to be completely out of the view. Thus, motion compensation is critical to obtaining reasonable confocal imaging in vivo—especially when video imaging is required. Therefore, there remains a need for improved motion-compensated confocal microscopes.

### SUMMARY

A motion-compensated confocal microscope according to an embodiment of the current invention includes a laser scanning system, a fiber-optic component having a proximal end and a distal end such that the fiber-optic component is optically coupled to the laser scanning system to receive illumination light at the proximal end and to emit at least a portion of the illumination light at the distal end, and a detection system configured to receive and detect light returned from a specimen being observed and to output an image signal. The light returned from the specimen is received by the distal end of the fiber-optic component and transmitted back and out the proximal end of the fiber-optic component. The motion-compensated confocal microscope also includes a motion compensation system connected to at least one of the distal end of the fiber-optic component or to the specimen to move at least one of the distal end of the fiber-optic component or the specimen to compensate for relative motion between the distal end of the fiber-optic component and a portion of the specimen being observed.

### BRIEF DESCRIPTION OF THE DRAWINGS

Further objectives and advantages will become apparent from a consideration of the description, drawings, and examples.

FIG. 1 is a schematic illustration of a motion-compensated confocal microscope according to an embodiment of the current invention.

FIG. 2A provides a system control flowchart; and FIG. 2B provides a corresponding speed control curve according to an embodiment of the current invention.

FIGS. 3A-3C show examples of: (a) Image in focus; (b) Image 50 microns out of focus; (c) Depth response of the confocal system, measured by moving ideal mirror along z axis. (scale bar: 100 μm).

FIGS. 4A and 4B show an example of: (a) Image without motion compensation; (b) Image with motion compensation (scale bar: 100 μm).

FIGS. 5A-5D show sequential images without motion compensation; FIGS. 5E-5H show sequential images with motion compensation (scale bar: 100 μm).

FIG. 6A shows (a) Focus error (no compensation) variation with time; FIG. 6B shows (b) Focus error (with compensation) variation with time: minus means toward probe, positive means away from probe.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

Some embodiments of the current invention provide a motion compensated fiber-optic confocal microscope system. Some examples demonstrate employing a Fourier domain common-path optical coherence tomography (CP-OCT) distance sensor and a high-speed linear motor at the distal end of the fiber optic confocal microscope imaging probe according to an embodiment of the current invention. The fiber-optic confocal microscope in this example is based on a 460 micron diameter fiber bundle terminated with a gradient index (GRIN) lens. Using the peak detection of 1-D A-scan data of CP-OCT, the distance deviation from the focal plane was monitored in real-time. When the distance deviation surpasses a pre-determined value, the linear motor moves the confocal microscope probe to maintain the deviation within a predetermined value. The motion compensation was achieved for a confocal microscope imaging rate of 1 Hz, with an average distance error of 2 microns in the examples.

A system according to some embodiments of the current invention can correct intra-frame and inter-frame distortion caused by biological activities of live samples, for example, such as breathing, heart beating, and blood flowing during in vivo confocal microscopy imaging to improve the imaging quality of confocal microscopes.

For imaging probes with a small field of view held perpendicular to the samples, image distortion is mainly caused by the axial motion of the sample which moves the sample's imaging surface away from the focal plane. Common-path optical coherence tomography (CP-OCT) has recently been demonstrated with its ability to precisely sense distance and has compact features for instrument integration [13-15].

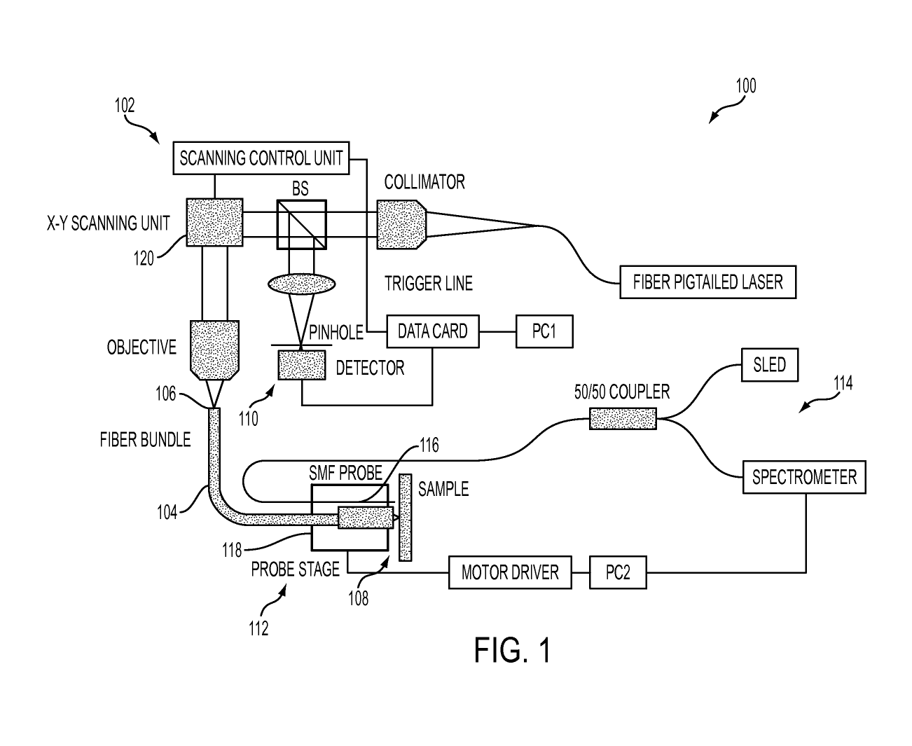

FIG. 1 is a schematic illustration of a motion-compensated confocal microscope 100 according to an embodiment of the current invention. The motion-compensated confocal microscope 100 includes a laser scanning system 102, a fiber-optic component 104 having a proximal end and a distal end 108 such that the fiber-optic component 104 is optically coupled to the laser scanning system 102 to receive illumination light at the proximal end 106 and to emit at least a portion of said illumination light at the distal end 108. The motion-compensated confocal microscope 100 also includes a detection system 110 configured to receive and detect light returned from a specimen (sample) being observed and to output an image signal. The light returned from the specimen is received by the distal end 108 of the fiber-optic component 104 and transmitted back and out the proximal end 106 of the fiber-optic component 104.

The motion-compensated confocal microscope 100 further includes a motion compensation system 112 connected to at least one of the distal end 108 of the fiber-optic component 104 or to the specimen to move at least one of the distal end 108 of the fiber-optic component 104 or the specimen to compensate for relative motion between the distal end 108 of said fiber-optic component 104 and a portion of the specimen being observed.

In an embodiment of the current invention, the motion compensation system 112 can include a distance detector 114 arranged to detect a relative distance between the distal end 108 of the fiber-optic component 104 and the portion of the specimen being observed. The distance detector 114 can be a common-path Fourier domain optical coherence tomography system in an embodiment that includes an optical fiber probe 116 having an end fixed at a substantially constant position relative to the distal end 108 of the fiber-optic component 104.

In an embodiment of the current invention, the motion compensation system 112 can also include a moveable stage 118 attached to the distal end 108 of the fiber-optic component 104. Although not shown in FIG. 1, an alternative embodiment could include a movable stage to hold the sample or specimen which could be adjusted relative to the distal end 108 of the fiber-optic component 104. Although more complicated, a further embodiment could include multiple movable stages. The primary issue is being able to determine and adjust the relative separation between the distal end 108 of the fiber-optic component 104 and the portion of the specimen being observed to compensate for motion. A platform and OCT sensor system that is suitable for use with current invention is described in international PCT application no. PCT/US2011/044693, published as WO 2012/012540 A2, which is assigned to the same assignee as the current application, the entire content of which is hereby incorporated by reference for all purposes.

In an embodiment of the current invention, the fiber-optic component 104 can be, or can include, an optical fiber bundle. The fiber-optic component 104 can further include a gradient refractive index (GRIN) lens at the distal end 108 of the fiber-optic component 104 according to some embodiments of the current invention. In some embodiments, two or more GRIN lenses can be used. In another embodiment of the current invention, the fiber-optic component 104 can further include an imaging system at the distal end 108 of the fiber-optic component 104.

In some embodiments of the current invention, the laser scanning system 102 can further include a light scanning unit 120 configured to scan a laser beam of light across the proximal end 106 of the fiber-optic component 104 to thereby scan illumination and detection across a portion of the specimen. In an embodiment of the current invention, the laser scanning unit 120 can include a Galvanic mirror system, for example.

In some embodiments of the current invention, the motion compensation system 112 can perform motion compensation in real time such that the motion compensation is performed on a frame-by-frame basis as the laser scanning unit 120 completes each scan.

### EXAMPLES

The following examples are provided to help explain some concepts of the current invention. The broad concepts of the current invention are not limited to these specific examples.

### Experiment Setup

GRIN Lens Terminated Fiber Bundle Probe

A fiber bundle probe terminated with GRIN lenses was assembled by gluing two GRIN lenses together at the distal end of a fiber bundle (Fujikura FIGH-10-500N, with an imaging diameter of 460 μm and 10K fiber cores) using UV curing adhesive. We used the GRIN lenses (NT64-525, 0.25 pitch, N.A.=0.55 and NT64-526, 0.23 pitch, N.A.=0.55) from Edmund Optics. The length of the 0.25 pitch lens was 4.34 mm; the length of the 0.23 pitch lens was 3.96 mm. When assembled, Zemax [16] simulation showed a working distance of 200 microns with a 1× image magnification. However, our experiment showed a working distance of ˜140 microns with a 1× image magnification for the probe. This was due to the forming of a small gap between the two GRIN lenses during the assembling process.

### Axial Motion Compensated Confocal Scanning System

We built an axial motion-compensated confocal microscope system according to an embodiment of the current invention by combining a fiber-bundle-based confocal microscope with a CP-OCT distance sensor. The schematic of the whole system is shown in FIG. 1. We used a fiber pigtailed diode laser (Meshtel, MFM-635-2S) with a wavelength of 635 nm as the confocal imaging light source. We used an objective lens (Olympus Plan N, 10×/0.25) as the collimator. A polarization-insensitive beam-splitter (CM1-BS013, Thorlabs) was used to direct the reflected signal beam onto the photon detector. The beam was coupled into the fiber bundle by an objective lens (Olympus Plan N, 20×/0.40). We used a focusing lens with a focal length f=60.0 mm and a pinhole of size 50 μm in front of the photon detector. The 2D scanning Galvo Mirror System was controlled by a function generator (Tektronix, AFG30228), which also sent trigger to the data card (NI USB-6211, 16 Inputs, 16-bit, 250 kS/s) to synchronize data acquisition. We used a Personal Laptop (Lenovo ThinkPad T400, Intel® Core™ 2 Duo CPU @ 2.8 GHz) to acquire the image data.

A CP-OCT distance-sensing system was operated separately with the confocal scanning system. The light from a SUPERLUM Broadband Light Source (center wavelength: 878.6 nm, bandwidth: 180 nm) was coupled into a single-mode fiber by a 50/50 broadband coupler. The single-mode fiber probe was cleaved in a right angle to provide reflection at the fiber end. The Fresnel reflection at the fiber tip served as reference light. A needle tube was used to protect the single-mode fiber reference surface by leaving a distance offset between the fiber inside the tube and the tube tip. The back-reflected/scattered light from the reference and the sample was directly coupled into the fiber and routed by the coupler to a customized spectrometer.

The fiber bundle scanning probe and the single-mode fiber probe were glued together at the probe stage, which was connected to the shaft of a high-speed linear motor (LEGS-L01S-11, Piezo LEGS). We used Workstation (DELL, Precision T7500) to obtain the distance information from the CP-OCT signal and deliver commands to the linear motor through a motor driver.

### Motion Compensation Principle

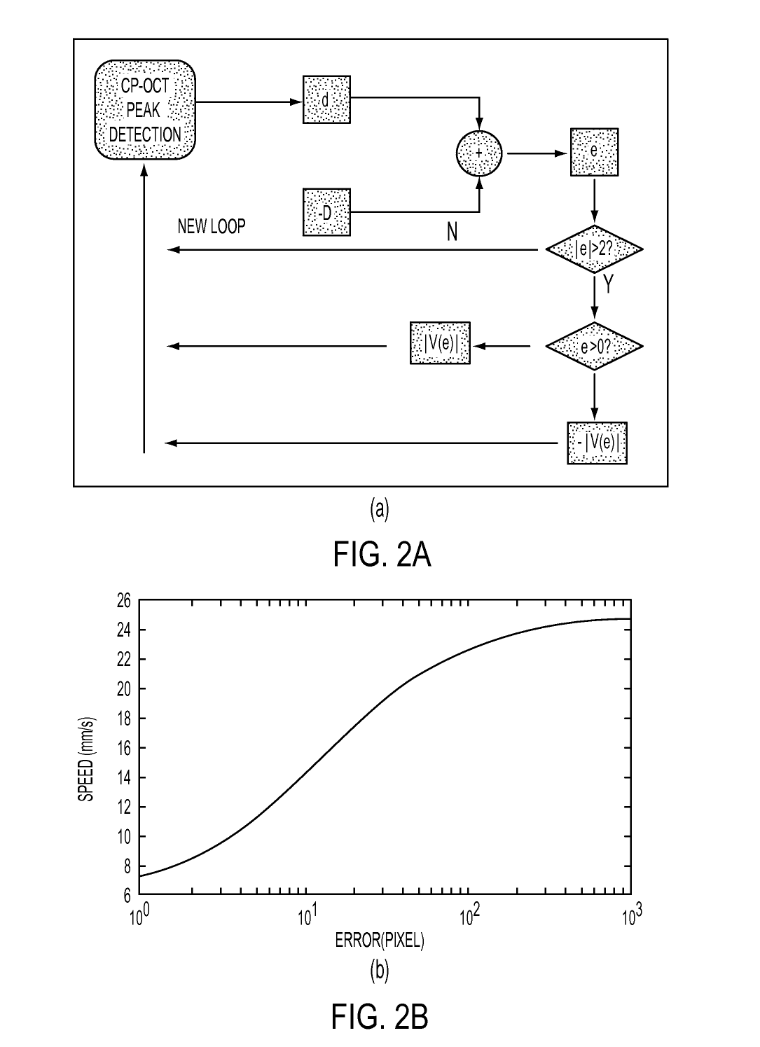

The LEGS-L01S-11 has a 35 mm travel range, 20 mm/s maximum speed, less than 1 nm resolution depending on different control modes, and a 10N maximum driving force. The CP-OCT system has an axial resolution of 3.6 micron in air and 2.8 micron in water. Using the peak detection [17], we achieved a position accuracy of 1.6 micron. The reference signal is obtained from a partial reflector near the distal end of the fiber-optic probe. Any distance can be measured from the reference plane by analyzing the CP-OCT spectral signal where the absolute value of the optical distance can be simply calculated from d=λ²/2nδλ where δλ, is the spectral modulation period detected by the OCT spectrometer and n is the refractive index. To validate its accuracy, we measured the d deduced from the OCT corresponding to the change in displacement of nerve tissue placed on top of a precision translation stage. We found a distance error of ±1.6 μm. As long as the OCT peak is above 10 dB above the noise floor, the distance accuracy remains relatively constant and for most surfaces provides more than 30 dB peaks. The system control flowchart is shown in FIG. 2A. Ideal imaging distance D is predetermined, the CP-OCT sensor measures the actual distance, d. The error signal, e is generated which is proportional to the difference between the ideal and actual distances. If e is less than 2 pixel distance, the velocity of motor remains zero. If e is larger than 2 pixels, voltage proportional to the difference is generated and drives the motor to a new position. The sensor measures the distance again and the whole loop is repeated at the rate of 840 Hz. Therefore the CP-OCT distance-sensing system ran at 840 A-scan corrections per second and monitored the distance between the fiber bundle probe and the target at 840 Hz. When the distance varied over 3.2 micron, the computer sent a command to the motor to move the probe to minimize the distance error to zero.

### Results and Discussion

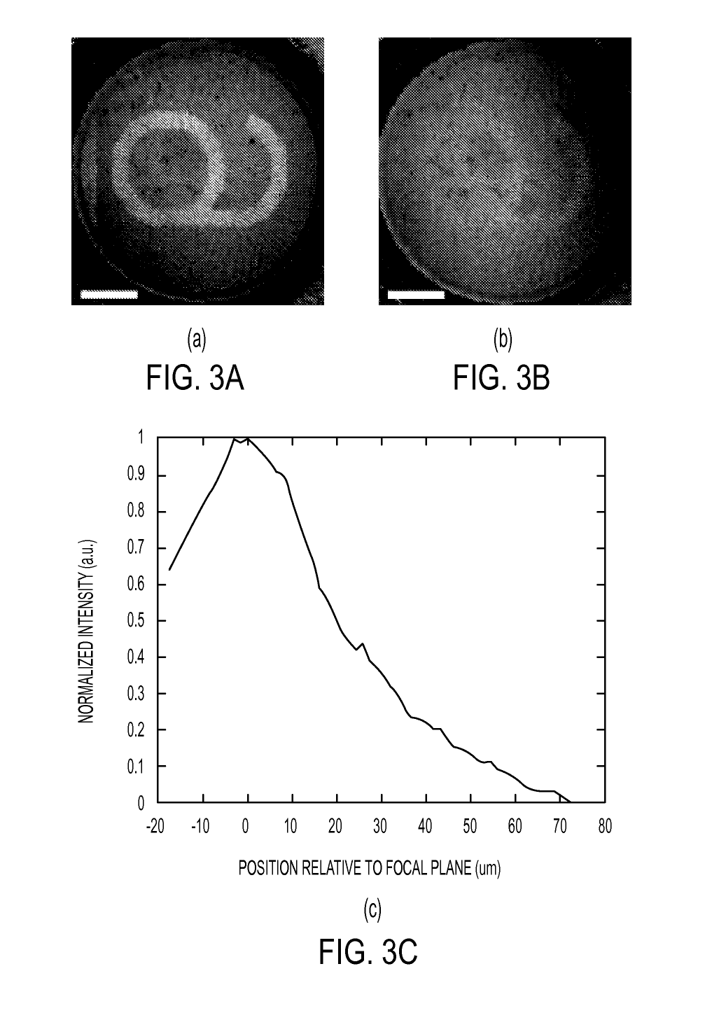

The fiber bundle has 10K cores and the imaging plain was over-sampled 200 pixels by 200 pixels (460 micron by 460 micron) to follow the Nyquist Sampling theorem. To obtain good image quality, the data card was set at a sampling rate of 40 K/s, which sets the imaging frame rate to ˜1 fps. NBS 1963A Resolution Target was used as test sample. By choosing a pinhole size of ˜50 micron in front of the detector, we effectively suppressed background and non-signal rays while maintaining a relatively high sensitivity. The axial resolution of the confocal system was ˜40 microns, this was measured using a mirror as a target and moving the target along the axial direction of the confocal microscope. The peak signal to noise ratio measured using the mirror target was 22 dB. A typical SNR for the airforce target was 20 dB. When we moved the glass sample 50 microns away from the focal plane, the target ‘number 6’ completely disappeared, as shown in FIGS. 3A and 3B.

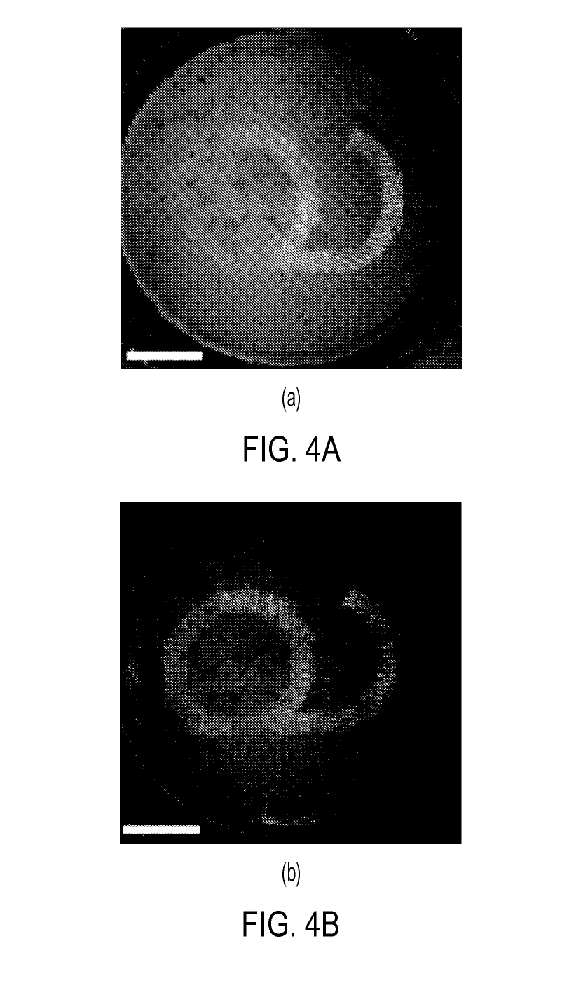

We placed the sample on a Newport XYZ 3D translation stage to simulate target movement. During image acquisition, the stage was driven back and forth along the axial direction of the probe. Without the motion compensation, some part of the frame comes into focus while some part of the frame is out of focus (intra-frame distortion). The consequence of the target movement is that some part of the image will be annulled by the depth discrimination of the confocal microscopy. With the motion compensation, the whole frame remains in focus, as is shown in FIG. 4B.

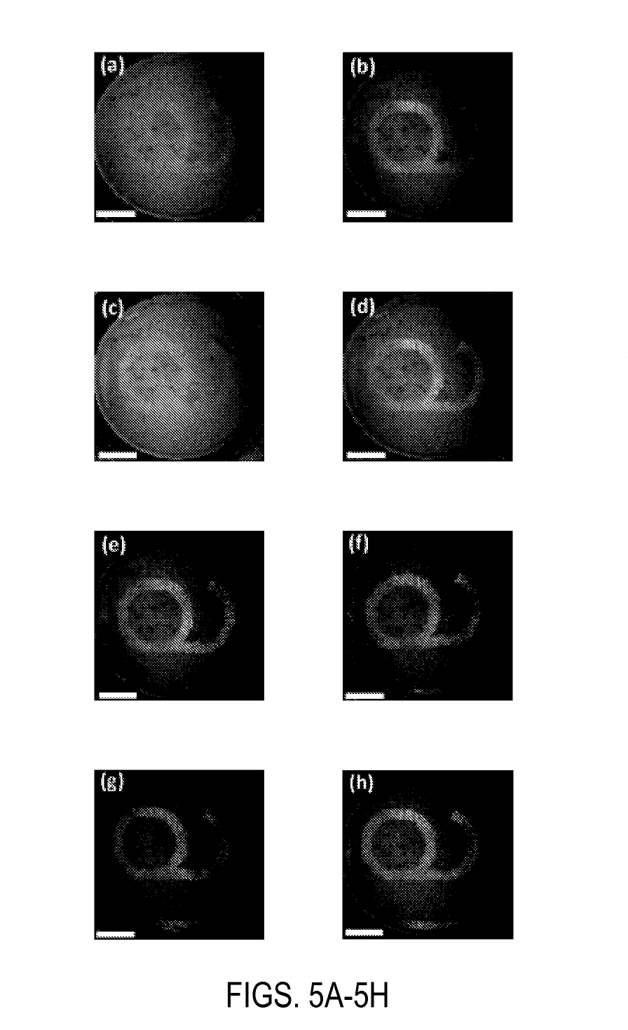

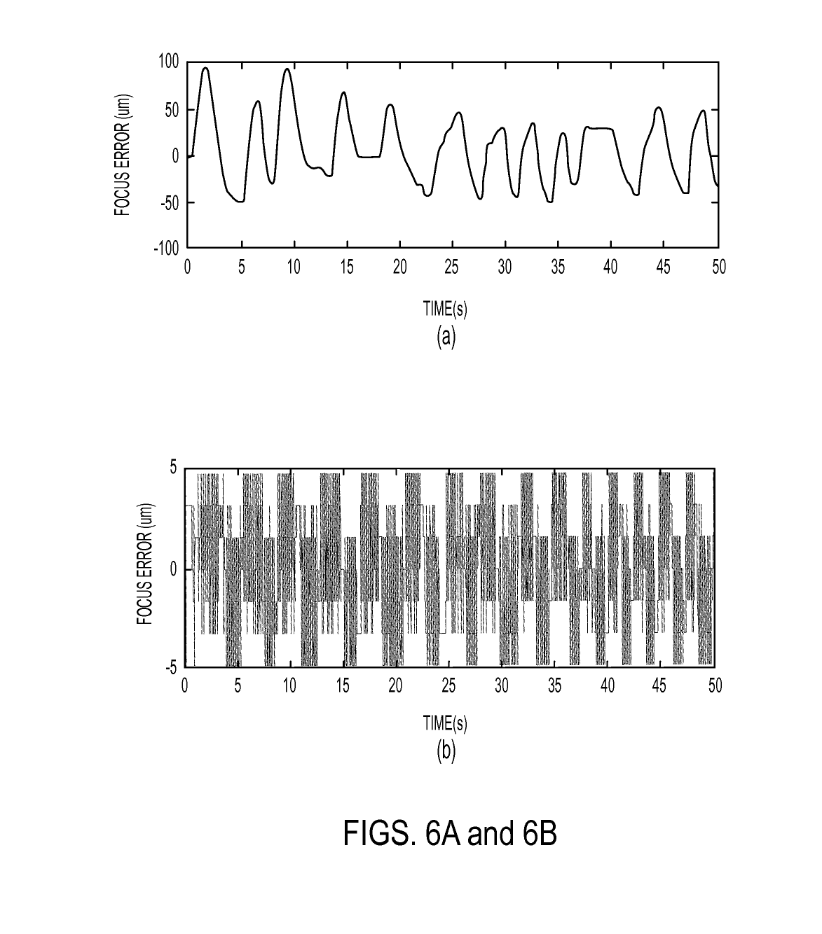

To show the influence of the motion compensation on inter-frame distortion, two sets of images were recorded over 50 seconds as is shown in FIGS. 5A-5H. FIGS. 5A-5D presents four sequential images taken without motion compensation while the sample stage was periodically driven back and forth. FIGS. 5E-5H show four sequential images taken with the motion compensation. We can clearly see that the CP-OCT-based motion compensation system can track the focal plane effectively, providing clear, in-focus images. To further study the stability and precision of motion compensation, sample displacement relative to the focal plane without and with the motion compensation was recorded and plotted in FIGS. 6A and 6B, respectively. As shown in FIG. 6A, the amplitude of the motion added to the sample stage was ˜60 micron and the frequency was ˜0.3 Hz. The average speed of the sample motion was 80 μm/s during the test. It took 1.19 ms for completion of each position correction cycle that was the single control loop time constant for the system. The theoretical maximum speed of the motion that the FD-CP-OCT system can compensate is ˜10 mm/s, which is half of the maximum speed of the linear motor. When the compensation was on as shown in FIG. 6B, the focus error was small and very stable, oscillating with maximum amplitude of 4.8 micron relative to the focal plane. The error jumps relatively high when the motion direction is changed, which is commonly known as “over-shoot.” Increasing the distance-sensing and correction rate above 840 per second can decrease the compensation over-shoot.

In this example, our results indicate that the system can compensate motion amplitude up to 60 microns at the rate of 840 Hz while maintaining a sample focus error within 5 microns. However, the concepts of the current invention are not limited to this example.

### REFERENCES

1. James G. Fujimoto, Daniel L. Farkas, Biomedical Optical Imaging, Oxford University Press, Inc. 198 Madison Avenue, New York, N.Y. 10016 (2009).
2. T. Dabbs, Monty Glass, “Fiber-optic confocal microscope: FOCON,” Appl. Opt. 31(16), 3030 (1992).
3. Do-Hyun Kim, Ilko K. Ilev, and Jin U. Kang, “Fiber-Optic Confocal Microscopy Using a 1.55 mm Fiber Laser for Multimodal Biophotonics Applications,” Journal of Special Topics in Quantum Electronics, vol. 14(1), 82-87 (2008).
4. Do-Hyun Kim, Ilko Ilev, Jin U. Kang, “Advanced Confocal Microscope Using Single Hollow-Core Photonic Bandgap Fibre Design,” IEE Electron. Lett., vol. 43(11) 608-609 (2007).
5. A. F. Gmitro, and D. Aziz, “Confocal microscopy through a fiber-optic imaging bundle,” Opt. Let. 18, 565 (1993)
6. C. Liang, M. Descour, K. B. Sun, and R. Richards-Kortum, “Fiber confocal reflectance microscope (FCRM) for in-vivo imaging,” Opt. Express. 9, 821-830 (2001).
7. W. Göbel, J. N. D. Kerr, A. Nimmerjahn, and F. Helmchen, “Miniaturized two-photon microscope based on a flexible coherent fiber bundle and a gradient-index lens objective,” Opt. Lett. 29, 2521-2523 (2004).
8. T. Xie, D. Mukai, S. Guo, M. Brenner, and Z. Chen, “Fiber-optic-bundle-based optical coherence tomography,” Opt. Lett. 30, 1803-1805 (2005).
9. J. Han, X. Liu, C. G. Song, and J. U. Kang, “Common path optical coherence tomography with fibre bundle probe,” Electron. Lett. 45(22), 1110-1112 (2009).
10. J. Han, J. Lee, and J. U. Kang, “Pixelation effect removal from fiber bundle probe based optical coherence tomography imaging,” Opt. Express. 18, 7427-7439 (2010).
11. J. Knittel, L. Schnieder, G. Buess, B. Messerschmidt, and T. Possner, “Endoscope-compatible confocal microscope using a gradient index-lens system,” Opt. Comm. 188, 267-273 (2001).
12. Radu G. Cucu, Mark W. Hathaway, Adrian Gh. Podoleanu, Richard B. Rosen, “Active axial eye motion tracking by extended range, closed loop OPD-locked white light interferometer for combined confocal/en face optical coherence tomography imaging of the human eye fundus in vivo,” Proc. of SPIE-OSA Biomedical Optics, SPIE Vol. 7372, 73721R (2009).
13. K. Zhang, W. Wang, J. Han, J. U. Kang, “A surface topology and motion compensation system for microsurgery guidance and intervention based on common-path optical coherence tomography,” IEEE Trans. Biomed. Eng. 56, 2318-2321 (2009).
14. K. Zhang, K. G. Petrillo, P. L. Gehlbach, and J. U. Kang, “A Free-Hand Surface Tracking and Motion Compensation Microsurgical Tool System based on Common-path Optical Coherence Tomography Distance Sensor,” in Conference on Lasers and Electro-Optics, OSA Technical Digest (CD) (Optical Society of America, 2010), paper CTuB6. http://www.opticsinfobase.org/abstract.cfm?uri=CLEO-2010-CTuB6
15. Kang Zhang, Elizabeth Katz, Do-Hyun Kim, Jin U. Kang and Ilko K. Ilev, “A Fiber-Optic Nerve Stimulation Probe Integrated with a Precise Common-Path Optical Coherence Tomography Distance Sensor,” in OSA CLEO/IQEC 2010, CTuP2. http://www.opticsinfobase.org/abstract.cfm?URI=CLEO-2010-CTuP2
16. ZEMAX is a product of Focus Software, Inc., Tucson, Ariz., USA, http://www.zemax.com.
17. D. Stiffer, A. D. Sanchis Dufau, E. Breuer, K. Wiesauer, P. Burgholzer, O. Hoglinger, E. Gotzinger, M. Pircher, C. K. Hitzenberger, “Polarization-sensitive optical coherence tomography for material characterization and testing,” Insight-Non-Destructing Testing and Condition Monitoring, 47, 209-212 (2005).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A motion-compensated confocal microscope, comprising:
a laser scanning system;
a fiber-optic component having a proximal end and a distal end, said fiber-optic component being optically coupled to said laser scanning system to receive illumination light at said proximal end and to emit at least a portion of said illumination light at said distal end;
a detection system configured to receive and detect light returned from a specimen being observed and to output an image signal, wherein said light returned from said specimen is received by said distal end of said fiber-optic component and transmitted back and out said proximal end of said fiber-optic component; and
a motion compensation system connected to at least one of said distal end of said fiber-optic component or to said specimen to move at least one of said distal end of said fiber-optic component or said specimen to compensate for relative motion between said distal end of said fiber-optic component and a portion of said specimen being observed.

2. A motion-compensated confocal microscope according to claim 1, wherein said motion compensation system comprises a distance detector arranged to detect a relative distance between said distal end of said fiber-optic component and said portion of said specimen being observed.

3. A motion-compensated confocal microscope according to claim 2, wherein said distance detector is a common-path Fourier domain optical coherence tomography system comprising an optical fiber probe having an end fixed at a substantially constant position relative to said distal end of said fiber-optic component.

4. A motion-compensated confocal microscope according to claim 3, wherein said motion compensation system comprises a moveable stage attached to said distal end of said fiber-optic component.

5. A motion-compensated confocal microscope according to claim 4, wherein said fiber-optic component comprises an optical fiber bundle.

6. A motion-compensated confocal microscope according to claim 5, wherein said fiber-optic component further comprises a gradient refractive index lens at said distal end of said fiber-optic component.

7. A motion-compensated confocal microscope according to claim 5, wherein said fiber-optic component further comprises an imaging system at said distal end of said fiber-optic component.

8. A motion-compensated confocal microscope according to claim 5, wherein said laser scanning system further comprises a light scanning unit configured to scan a laser beam of light across said proximal end of said fiber-optic component to thereby scan illumination and detection across a portion of said specimen.

9. A motion-compensated confocal microscope according to claim 8, wherein said laser scanning unit comprises a Galvanic mirror system.

10. A motion-compensated confocal microscope according to claim 8, wherein said motion compensation system performs motion compensation in real time such that the motion compensation is performed on a frame-by-frame basis as said laser scanning unit completes each scan.
